(19) United States
(12) Patent Application Publication
(10) Pub. No.: US 2023/0111863 A1
(43) Pub. Date: Apr. 13, 2023

(54) METHOD OF CONTROLLING AN ENGINE OIL WARNING LIGHT OF A VEHICLE

(71) Applicants: HYUNDAI MOTOR COMPANY, Seoul (KR); KIA CORPORATION, Seoul (KR)

(72) Inventors: Hong Woon Jang, Suwon-si (KR); Min Gyun Chae, Hwaseong-si (KR)

(73) Assignees: HYUNDAI MOTOR COMPANY, Seoul (KR); KIA CORPORATION, Seoul (KR)

(21) Appl. No.: 17/956,374

(22) Filed: Sep. 29, 2022

(30) Foreign Application Priority Data
Oct. 12, 2021 (KR) 10-2021-0134778

(51) Int. Cl. F01M 11/10; B60Q 9/00

(52) U.S. Cl. CPC F01M 11/10; B60Q 9/00

(57) ABSTRACT

A method of controlling an engine oil warning light of a vehicle prevents deterioration of engine oil and reduced durability of an engine that would be caused by non-operation of an engine oil warning light. The method includes: calculating a pressure difference of engine oil; when the initial pressure difference is greater than a predetermined threshold pressure difference, changing a warning light operating pressure determination map; and determining whether or not to turn on an engine oil warning light based on the warning light operating pressure determined by the changed warning light operating pressure determination map.

### CROSS-REFERENCE TO RELATED APPLICATION

This application claims under 35 U.S.C. § 119(a) the benefit of priority to Korean Patent Application No. 10-2021-0134778 filed on Oct. 12, 2021, the entire contents of which are incorporated herein by reference.

### BACKGROUND

### (a) Technical Field

The present disclosure relates to a method of controlling an engine oil warning light of a vehicle, and more specifically, to a method of controlling an engine oil warning light of a vehicle in order to prevent deterioration of engine oil and reduced durability of an engine.

### (b) Background Art

In general, engine oil is generally used to lubricate and cool engines. Engine oil is stored in an oil pan disposed on the lower portion of an engine and is supplied to lubricated working parts of the engine using an oil pump. Engine oil circulates through the lubricated working parts of the engine at or above a predetermined pressure.

When engine oil is diluted, the viscosity of the engine oil may be reduced and thus the pressure of the oil may be occasionally reduced. When the pressure of the engine oil is lower than a threshold pressure, the lubricating and cooling function of the engine oil may be reduced and thus the durability of the engine may be reduced.

Thus, when the pressure of engine oil is lower than a predetermined threshold pressure, an engine oil warning light may be turned on to allow a driver to take actions for such a situation.

Engine oil is transferred to the engine using an oil pump. In addition, even in the case that oil pumps having the same performance are used, pressures of engine oil supplied into engines may be different depending on the internal structures of the engines. Thus, in engines, even at the same revolutions per minute (RPM), pressures of engine oil supplied to the engines may be different depending on the engine type.

Thus, as illustrated in FIG. 3, the pressure of engine oil has an upper threshold value (i.e., a maximum pressure) G1 and a lower threshold value (i.e., a minimum pressure) G2. Here, the engine oil warning light is turned on based on a threshold pressure (i.e., a warning light operating pressure) G3 determined to be a value lower than the minimum pressure G2 in a predetermined ratio. In other words, the warning light operating pressure G3 of the related art is determined based on the minimum pressure G2, irrespective of different engine oil pressures of the engines.

However, in an engine in which the engine oil pressure is equal to or higher than a mean pressure G4 of the maximum pressure G1 and the minimum pressure G2, the pressure of the engine oil may be significantly higher than the warning light operating pressure G3. Thus, even in the case that the engine oil pressure is reduced by a predetermined ratio or more, the warning light operating pressure G3 may not be reached. When the engine oil pressure does not reach the warning light operating pressure G3, the engine oil warning light is not turned on.

Even in the case that the engine oil pressure does not reach the warning light operating pressure G3, it may be necessary to inspect the engine oil when the pressure of the engine oil is significantly reduced. In other words, even in the case that the engine oil pressure does not reach the warning light operating pressure, when the pressure of the engine oil is reduced by a predetermined ratio or more, the engine oil warning light should be turned on.

When the engine oil warning light is not turned on although the pressure of the engine oil is reduced by a predetermined ratio or more, the lubricating and cooling function of the engine oil may be reduced as a result thereof. Thus, the durability of the engine may be reduced.

The above information disclosed in this Background section is only to enhance understanding of the background of the disclosure. Accordingly, the Background section may include information that does not form the prior art that is already known to a person of ordinary skill in the art.

### SUMMARY OF THE DISCLOSURE

The present disclosure has been made in an effort to solve the above-described problems associated with the related art. An object of the present disclosure is to provide a method of controlling an engine oil warning light of a vehicle in order to prevent deterioration of engine oil and reduced durability of an engine that would be caused by non-operation of an engine oil warning light.

The objects of the present disclosure are not limited to the aforementioned objects. Other objects not mentioned herein may be clearly understood by those with ordinary skill in the art to which the present disclosure pertains (hereinafter ‘those having ordinary skill in the art’) from the following description.

In one aspect, the present disclosure provides a method of controlling an engine oil warning light of a vehicle. The method includes calculating a pressure difference of engine oil by subtracting a predetermined mean pressure of the engine oil from an actual pressure of the engine oil measured when an engine is initially driven and determining the initial pressure difference to be a mean value of pressure difference values of the engine oil calculated while the engine is being initially driven. The method also includes, when the initial pressure difference is greater than a predetermined threshold pressure difference, changing a warning light operating pressure determination map, composed to determine a warning light operating pressure based on an engine revolutions per minute (RPM) and a temperature of the engine oil, such that a warning light operating pressure value is increased. The method also includes determining whether or not to turn on an engine oil warning light based on the warning light operating pressure determined by the changed warning light operating pressure determination map.

According to an embodiment of the present disclosure, the determining of whether or not to turn on the engine oil warning light may include turning on the engine oil warning light when the actual pressure of the engine oil measured in real time is equal to or lower than the warning light operating pressure determined by the changed warning light operating pressure determination map.

In addition, the determining of whether or not to turn on the engine oil warning light may include not turning on the engine oil warning light when the actual pressure of the engine oil measured in real time is higher than the warning light operating pressure determined by the changed warning light operating pressure determination map.

In addition, the method may further include, when the initial pressure difference is equal to or smaller than the threshold pressure difference, maintaining the warning light operating pressure determination map without a change and determining whether or not to turn on the engine oil warning light based on the warning light operating pressure determined by the original warning light operating pressure determination map.

In addition, the maintaining of the warning light operating pressure determination map may include, when the actual pressure of the engine oil measured in real time is equal to or lower than the warning light operating pressure determined by the original warning light operating pressure determination map, turning on the engine oil warning light.

In addition, the maintaining of the warning light operating pressure determination map may include, when the actual pressure of the engine oil measured in real time is higher than the warning light operating pressure determined by the original warning light operating pressure determination map, not turning on the engine oil warning light.

In addition, the mean pressure of the engine oil may be determined based on the engine RPM and the temperature of the engine oil when the actual pressure of the engine oil is measured.

In addition, the mean pressure of the engine oil may be determined to be a mean value of a maximum pressure of engine oil and a minimum pressure of engine oil. The maximum pressure of engine oil may be a highest pressure value of engine oil among pressure values of engine oil supplied to different types of engines. The minimum pressure of engine oil may be a lowest pressure value of engine oil among pressure values of engine oil supplied to different types of engines.

In addition, the changing of the warning light operating pressure determination map may change the warning light operating pressure determination map such that only the warning light operating pressure value is increased without a change in the engine RPM and the temperature of the engine oil when changing the warning light operating pressure determination map.

According to embodiments, the method of the present disclosure can turn the engine oil warning light on at a point in time at which the engine oil warning light is required to operate, irrespective of different engine oil pressures depending on the engine type. Thus, deterioration of engine oil and reduced durability of an engine may be prevented.

The effects of the present disclosure is not limited to the aforementioned effects. Other effects not mentioned herein may be clearly recognized by those having ordinary skill in the art from the following description.

### BRIEF DESCRIPTION OF THE DRAWINGS

The above and other features of the present disclosure are now described in detail with reference to certain examples of the present disclosure illustrated in the accompanying drawings. The accompanying drawings are given herein below by way of illustration only and thus do not limit the present disclosure, and wherein:

FIG. 1 is a graph illustrating a warning light operating pressure determination map moved up as an example by a method of controlling an engine oil warning light of a vehicle according to embodiments of the present disclosure;

FIG. 2 is a flowchart illustrating the method of controlling an engine oil warning light of a vehicle according to embodiments of the present disclosure; and

FIG. 3 is a conceptual view illustrating a method of controlling an engine oil warning light of the related art.

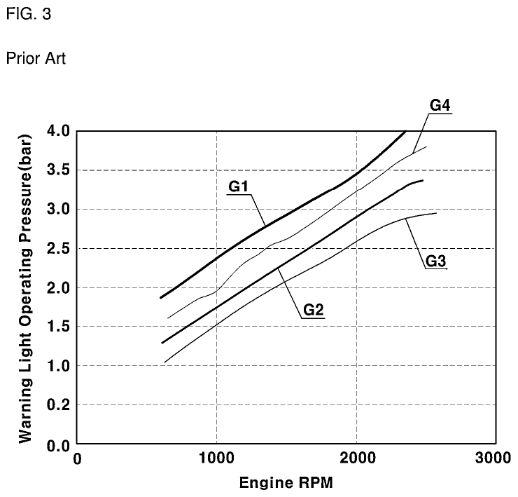

### DETAILED DESCRIPTION

Specific structural or functional descriptions presented in embodiments of the present disclosure are only exemplified for the purpose of describing the embodiments according to the concept of the present disclosure. The embodiments according to the concept of the present disclosure may be carried out in various forms. Further, the embodiments should not be interpreted as being limited to the embodiments described in the present specification. The embodiments should be understood as including all modifications, equivalents, and substitutes included in the spirit and technical scope of the present disclosure.

Throughout the specification, when a portion “comprises (or includes)” a component, it should be understood that the portion may further include another component and the presence of another component is not precluded unless specified to the contrary.

In addition, terms, such as “module” or “unit,” refer to elements respectively performing at least one function or operation. A component expressed with such a term may be implemented as a software module operated by a set program, a hardware module comprised of electric/electronic elements, or a combination module in which the software module and the hardware module are combined. When a module, unit, component, device, element, or the like of the present disclosure is described as having a purpose or performing an operation, function, or the like, the module, unit, component, device, or element should be considered herein as being “configured to” meet that purpose or to perform that operation or function.

Hereinafter, embodiments of the present disclosure are described with reference to the accompanying drawings. Illustrations of the drawings are provided to easily describe the embodiments of the present disclosure and may differ from actually implemented methods or forms thereof.

The present disclosure provides a method of controlling an engine oil warning light in order to obtain and increase the reliability of the operation of an engine oil warning light mounted on a vehicle.

The engine oil warning light is turned on in a situation in which the pressure of circulating engine oil supplied to an engine is determined to be low. The engine oil warning light being turned on may induce user actions for the situation in which the pressure of engine oil is reduced.

Engine oil is transferred to the engine using an oil pump, and the amount of engine oil transferred to the engine using the oil pump is determined in proportion to the revolutions per minute (RPM) of the engine.

In addition, even in the case that oil pumps having the same performance are used, pressures of engine oil supplied into engines may be different depending on the internal structures of the engines. In other words, even at the same engine RPM, pressures of engine oil supplied to engines may be different depending on the engine type.

Thus, the pressure of engine oil has an upper threshold value (i.e., a maximum pressure) and a lower threshold value (i.e., a minimum pressure) depending on the engine type. Here, the engine oil warning light is turned on based on a threshold pressure (i.e., a warning light operating pressure) determined to be a value lower than the minimum pressure by a predetermined ratio. In other words, the warning light operating pressure of the related art is determined based on the minimum pressure, irrespective of different engine oil pressures of the engines.

Thus, in an engine in which the pressure of engine oil is equal to or higher than a mean pressure of the maximum pressure and the minimum pressure, the warning light operating pressure may not be reached, even in the case that the pressure of the engine oil is reduced by a predetermined ratio or more. When the pressure of the engine oil does not reach the warning light operating pressure, the engine oil warning light is not turned on.

Accordingly, the present disclosure provides a method of controlling an engine oil warning light able to obtain and increase the reliability of the operation of an engine oil warning light, irrespective of different engine oil pressures occurring depending on the engine type.

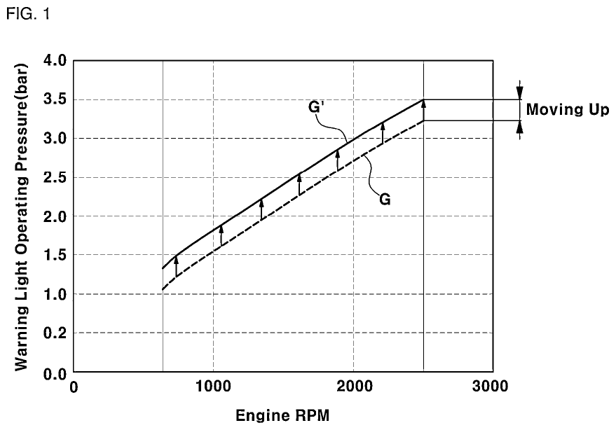

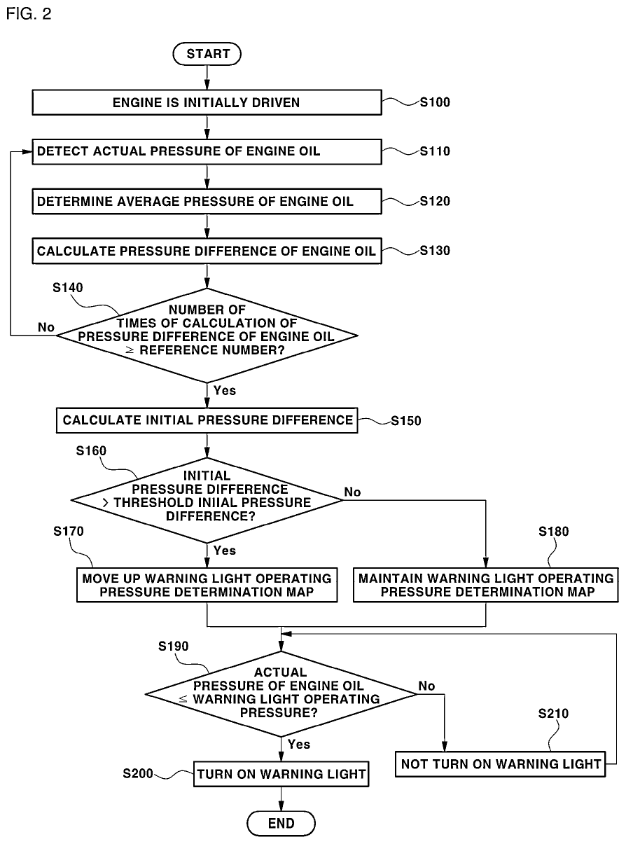

In the accompanying drawings, FIG. 1 is a graph illustrating a warning light operating pressure determination map that is increased or moved up as an example by a method of controlling an engine oil warning light of a vehicle according to embodiments of the present disclosure. FIG. 2 is a flowchart illustrating the method of controlling an engine oil warning light of a vehicle according to embodiments of the present disclosure.

When an initial pressure difference calculated based on an actual pressure of engine oil measured when the engine is initially driven is greater than a predetermined threshold pressure difference, the method of controlling an engine oil warning light according to the present disclosure moves up the warning light operating pressure determination map in a direction in which warning light operating pressure values are increased, as illustrated in FIG. 1.

For example, the threshold pressure difference may be determined to be zero (0) or a positive value approximate to 0.

The warning light operating pressure determination map is configured to determine each of the warning light operating pressure values based on the engine RPM (i.e., the rotation speeds of the engine) and the temperatures of the engine oil. The warning light operating pressure is a threshold pressure of engine oil at which the engine oil warning light is started to be turned on.

When the actual pressure of the engine oil is equal to or lower than the warning light operating pressure determined by the warning light operating pressure determination map, the engine oil warning light is turned on. The actual pressure of the engine oil is a pressure of the engine oil actually measured by an oil pressure sensor.

The warning light operating pressure determination map is composed in advance and stored in a control unit. The control unit is a controller configured to execute the method of controlling an engine oil warning light according to the present disclosure. The control unit may be implemented as at least one controller provided inside a vehicle. For example, the control unit may be an engine controller in charge of overall control of the engine. In addition, the method of controlling an engine oil warning light according to the present disclosure may be executed by two or more controllers provided inside the vehicle. The controller may include one or more processors and a memory, such as a non-transitory memory and may include operational software configured or programmed to perform the functions of the controller.

Hereinafter, the method of controlling an engine oil warning light according to embodiments of the present disclosure is described with reference to FIG. 2.

As illustrated in FIG. 2, when the engine is initially driven in S100, the control unit detects an actual pressure of engine oil by the oil pressure sensor in S110.

Here, the engine being initially driven means that the engine is driven first time after the vehicle on which the engine is mounted was shipped from a factory.

The actual pressure of the engine oil is a pressure value of the engine oil measured in real time by the oil pressure sensor. The oil pressure sensor measures a pressure value of the engine oil sent by an oil pump and transmits the pressure value to the control unit. The oil pump sends and supplies engine oil into the engine. The oil pressure sensor may periodically measure the pressure of the engine oil while the engine is being driven.

The control unit determines a mean pressure of the engine oil based on the engine RPM and the temperature of the engine oil when the actual pressure of the engine oil is measured in S120. The mean pressure of the engine oil is determined by the mean pressure of engine oil determination map.

The mean pressure of engine oil determination map is configured to determine the mean pressure of the engine oil based on the engine RPM and the temperature of the engine oil. The mean pressure of engine oil determination map is determined in advance and stored in the control unit. The mean pressure of the engine oil is a mean value of a maximum pressure of engine oil and a minimum pressure of engine oil.

Even in the case that engine oil is sent to engines using oil pumps having the same performance, pressure values of engine oil may be different depending on the internal structure of the engines through which engine oil flows. In other words, even in the case that the oil pump is driven using the same power, engine oil may have different pressures depending on the engine type. Thus, the maximum pressure of engine oil and the minimum pressure of engine oil are present based on the same engine RPM and the same temperature of engine oil depending on the engine type.

The maximum pressure of engine oil is a greatest or highest pressure value of engine oil among pressure values of engine oil supplied to different types of engines, based on the same engine RPM and the same temperature of engine oil. The minimum pressure of engine oil is a lowest or smallest pressure value of engine oil among pressure values of engine oil supplied to different types of engines, based on the same engine RPM and the same temperature of engine oil.

In general, the oil pump is driven by receiving power through the crankshaft of the engine. The pressure of the engine oil sent to the engine by the oil pump increases in proportion to the engine RPM.

The control unit calculates a pressure difference of the engine oil by subtracting the mean pressure of the engine oil from the actual pressure of the engine oil in S130. The pressure difference of the engine oil means a pressure difference in the actual pressure of the engine oil and the mean pressure of the engine oil.

The control unit periodically calculates the pressure difference of the engine oil while the engine is being initially driven. The control unit cumulatively sums the number of times of calculation by which the pressure difference of the engine oil is calculated whenever the pressure difference of the engine oil is calculated while the engine is being initially driven. The control unit determines whether the number of times of calculation of the pressure difference of the engine oil is equal to or greater than a predetermined reference number of times in S140.

When the number of times of calculating the pressure difference of the engine oil is equal to or greater than the reference number of times (Yes in S140), the control unit calculates an initial pressure difference in S150. When the number of times of calculating the pressure difference of the engine oil is less than the reference number of times (No in S140), the control unit detects the actual pressure of the engine oil again in S110 and determines the mean pressure of the engine oil again in S120. In other words, when the number of times of calculating the pressure difference of the engine oil is less than the reference number of times, the control unit does not calculate the initial pressure difference.

The initial pressure difference Dintial is a value obtained by dividing a sum of pressure difference values Pn of the engine oil, calculated repeatedly by the reference number of times N, with the reference number of times N. In other words, the initial pressure difference Dintial is a mean value of the pressure difference values Pn of the engine oil calculated repeatedly by the reference number of times N. The initial pressure difference Dintial is calculated as in the following Equation 1:

Dintial=(P1+P2+P3+ . . . +Pn)/N Equation 1:

Here, the engine is continuously driven until at least the number of times of calculating the pressure difference of engine oil reaches the reference number of times.

The control unit compares the initial pressure difference with a predetermined threshold pressure difference in S160. When the initial pressure difference is greater than the threshold pressure difference (Yes in S160), the control unit moves up the warning light operating pressure determination map in S170.

Here, moving up the warning light operating pressure determination map means changing the warning light operating pressure determination map so as to increase the warning light operating pressure values determined based on the engine RPM and the temperature of engine oil.

In other words, moving up the warning light operating pressure determination map means moving up the warning light operating pressure determination map in a direction in which the warning light operating pressure values determined based on the engine RPM and the temperature of engine oil are increased (see FIG. 1).

In other words, moving up the warning light operating pressure determination map means changing the warning light operating pressure determination map such that only the warning light operating pressure values are increased, without a change in the engine RPM or the temperature of engine oil. In other words, moving up the warning light operating pressure determination map means that only the warning light operating pressure values are collectively increased at the same time without a change in the engine RPM or the temperature of engine oil. Here, the warning light operating pressure values of the warning light operating pressure determination map are increased in the same ratio.

In addition, when the initial pressure difference is equal to or smaller than the threshold pressure difference (No in S160), the control unit maintains the warning light operating pressure determination map without a change in S180. In other words, when the initial pressure difference is equal to or smaller than the threshold pressure difference, the control unit does not move up the warning light operating pressure determination map. Here, not moving up the warning light operating pressure determination map means that the warning light operating pressure determination map is not changed.

When the warning light operating pressure determination map is moved up, all of the warning light operating pressure values determined by the warning light operating pressure determination map are collectively increased by a predetermined pressure value.

For example, as illustrated in FIG. 1, the warning light operating pressure determination map G may be moved up by 0.25 bar. In this case, the warning light operating pressure determined by the moved-up warning light operating pressure determination map G′ is determined to be a pressure value increased from the warning light operating pressure, determined by the original warning light operating pressure determination map G, by 0.25 bar.

The control unit determines whether or not to move up (i.e., change) the warning light operating pressure determination map and then determines whether or not to turn on the engine oil warning light depending on a result of comparing the actual pressure of engine oil with the warning light operating pressure.

When the warning light operating pressure determination map is moved up, the control unit determines whether or not to turn on the engine oil warning light based on the warning light operating pressure determined by the moved-up warning light operating pressure determination map.

In other words, when the warning light operating pressure determination map is changed such that the warning light operating pressure value is increased, the control unit determines whether or not to turn on the engine oil warning light based on the warning light operating pressure determined by the changed warning light operating pressure determination map.

Here, the control unit compares the actual pressure of engine oil measured in real time with the warning light operating pressure determined by the changed warning light operating pressure determination map in S190. When the actual pressure of the engine oil is equal to or lower than the warning light operating pressure (Yes in S190), the control unit turns on the engine oil warning light in S200. When the actual pressure of the engine oil is higher than the warning light operating pressure (No in S190), the control unit does not turn on the engine oil warning light in S210.

In addition, when the warning light operating pressure determination map is not moved up, the control unit determines whether or not to turn on the engine oil warning light based on the warning light operating pressure determined by the original warning light operating pressure determination map that has not been moved up.

In other words, when the warning light operating pressure determination map is not changed, the control unit determines whether or not to turn on the engine oil warning light based on the warning light operating pressure determined by the original warning light operating pressure determination map that has not been changed.

Here, the control unit compares the actual pressure of engine oil measured in real time with the warning light operating pressure determined by the original warning light operating pressure determination map in S190. When the actual pressure of the engine oil is equal to or lower than the warning light operating pressure (Yes in S190), the control unit turns on the engine oil warning light in S200. When the actual pressure of the engine oil is higher than the warning light operating pressure (No in S190), the control unit does not turn on the engine oil warning light in S210.

Whenever the engine is driven, the control unit determines whether or not to turn on the engine oil warning light based on the warning light operating pressure. The warning light operating pressure is a warning light operating pressure determined by the changed warning light operating pressure determination map or a warning light operating pressure determined by the original warning light operating pressure determination map that has not been changed.

Although the embodiments of the present disclosure have been described in detail hereinabove, the terms or words used in the present specification and the claims should not be interpreted as a limitation to common and dictionary meanings.

What is claimed is:

1. A method of controlling an engine oil warning light of a vehicle, the method comprising:
calculating a pressure difference of engine oil by subtracting a predetermined mean pressure of the engine oil from an actual pressure of the engine oil measured when an engine is initially driven and determining the initial pressure difference to be a mean value of pressure difference values of the engine oil calculated while the engine is being initially driven;
when the initial pressure difference is greater than a predetermined threshold pressure difference, changing a warning light operating pressure determination map, composed to determine a warning light operating pressure based on an engine revolutions per minute (RPM) and a temperature of the engine oil, such that a warning light operating pressure value is increased; and
determining whether or not to turn on an engine oil warning light based on the warning light operating pressure determined by the changed warning light operating pressure determination map.

2. The method of claim 1, wherein the determining of whether or not to turn on the engine oil warning light comprises turning on the engine oil warning light when the actual pressure of the engine oil measured in real time is equal to or lower than the warning light operating pressure determined by the changed warning light operating pressure determination map.

3. The method of claim 1, wherein the determining of whether or not to turn on the engine oil warning light comprises not turning on the engine oil warning light when the actual pressure of the engine oil measured in real time is higher than the warning light operating pressure determined by the changed warning light operating pressure determination map.

4. The method of claim 1, further comprising, when the initial pressure difference is equal to or smaller than the threshold pressure difference, maintaining the warning light operating pressure determination map without a change and determining whether or not to turn on the engine oil warning light based on the warning light operating pressure determined by the original warning light operating pressure determination map.

5. The method of claim 4, wherein the maintaining of the warning light operating pressure determination map comprises, when the actual pressure of the engine oil measured in real time is equal to or lower than the warning light operating pressure determined by the original warning light operating pressure determination map, turning on the engine oil warning light.

6. The method of claim 4, wherein the maintaining of the warning light operating pressure determination map comprises, when the actual pressure of the engine oil measured in real time is higher than the warning light operating pressure determined by the original warning light operating pressure determination map, not turning on the engine oil warning light.

7. The method of claim 1, wherein the mean pressure of the engine oil is determined based on the engine RPM and the temperature of engine oil when the actual pressure of the engine oil is measured.

8. The method of claim 1, wherein the mean pressure of the engine oil is determined to be a mean value of a maximum pressure of engine oil and a minimum pressure of engine oil, wherein the maximum pressure of engine oil being a highest pressure value of engine oil among pressure values of engine oil supplied to different types of engines, and wherein the minimum pressure of engine oil being a lowest pressure value of engine oil among pressure values of engine oil supplied to different types of engines.

9. The method of claim 1, wherein the changing of the warning light operating pressure determination map changes the warning light operating pressure determination map such that only the warning light operating pressure value is increased without a change in the engine RPM and the temperature of the engine oil when changing the warning light operating pressure determination map.
